(19) United States
(12) Patent Application Publication
(10) Pub. No.: US 2026/0106834 A1
(43) Pub. Date: Apr. 16, 2026

(54) ADAPTING TO NETWORK CONGESTION IN VIRTUAL NETWORKS

(71) Applicant: Apple Inc., Cupertino, CA (US)

(72) Inventors: Mradul SAXENA, Sunnyvale, CA (US); Surya P. KONERU, Saratoga, CA (US); Varun VIJ, Sunnyvale, CA (US)

(21) Appl. No.: 19/299,282

(22) Filed: Aug. 13, 2025

Related U.S. Application Data
(60) Provisional application No. 63/706,606, filed on Oct. 11, 2024.

(51) Int. Cl. H04L 47/22; H04L 43/10; H04L 47/11

(52) U.S. Cl. CPC H04L 47/22; H04L 43/10; H04L 47/115

(57) ABSTRACT

Systems and methods provide for adjusting the distribution of network data packets based on the processing load of the physical gateway devices. A virtual switch transmits a sequence of probe packets over a virtual network to a first physical gateway device. The virtual switch determines a processing load based on the sequence of response packets received from the first physical gateway device. In response to determining that the processing load of the first physical gateway device is more than a pre-determined threshold, a ratio of subsequent data packet transmissions is adjusted for the first physical gateway device.

### CROSS-REFERENCE TO RELATED APPLICATIONS

The present application claims the benefit of U.S. Provisional Application No. 63/706,606, entitled “ADAPTING TO NETWORK CONGESTION IN VIRTUAL NETWORKS”, filed Oct. 11, 2024, the entirety of which is incorporated herein for reference.

### TECHNICAL FIELD

This disclosure relates to communication networks and in particular to adapting to network congestion detected at a network gateway, such as a network gateway experiencing a high processing load.

### BACKGROUND

A virtual network is an abstraction of traditional physical network, where the physical hardware devices like routers, switches, firewalls, and other network services are virtualized and managed through software. These virtual networks enable multiple networks to co-exist on the same physical infrastructure, providing an isolated, customizable network environment for different applications, users, or services. Virtual networks can span across data centers, cloud environments, and even geographical regions, enabling users to manage network resources with more flexibility.

### BRIEF DESCRIPTION OF THE DRAWINGS

Certain features of the subject technology are set forth in the appended claims. However, for the purpose of explanation, several aspects of the subject technology are set forth in the following figures.

FIG. 1 illustrates an example network environment according to aspects of the subject technology.

FIG. 2 illustrates an example computing architecture for a system implementing a virtual computing environment according to aspects of the subject technology.

FIG. 3 illustrates an example of the reachability agent transmitting a sequence of probe packets according to aspects of the subject technology.

FIG. 4 illustrates a flowchart according to aspects of the subject technology.

FIG. 5 illustrates an example electronic system with which aspects of the subject technology may be implemented in accordance with one or more implementations.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In some implementations, structures and components are shown in block diagram form to avoid obscuring the concepts of the subject technology.

A virtual network is a network that uses software to manage and control the flow of data, abstracting the underlying physical network infrastructure. It allows multiple isolated network environments to coexist on the shared physical hardware devices, such as servers, network interface cards (NICs), routers, switches, gateways, load balancers, etc. The virtualized approach enables flexibility to manage network traffic and network services entirely through software, eliminating the need to reconfigure physical hardware devices like routers, switches, and firewalls. In traditional physical networks, changes such as adding new hardware devices, adjusting routing rules, or implementing security policies require manual configuration of the physical hardware devices which may be time consuming and prone to errors. However, in virtual networks, these changes are done at the software level thereby abstracting the underlying physical network infrastructure.

In an example virtualized network environment, a virtual machine executing on a host server can communicate with a virtual switch executing on a dedicated server configured to facilitate communication between virtual machines across different host servers. To communicate with the virtual switches on other host servers (and/or with other devices), the virtual switch sends the outgoing network traffic through a physical gateway device corresponding to the host server. The physical gateway device may be, for example, a physical gateway device on a server, such as a commodity server. The physical gateway device forwards the network traffic to, for example, virtual switches on other host servers via an external network. The physical gateway device performs tasks such as IP routing, network address translation (NAT), and packet forwarding to ensure that the virtual machines in the virtual network can communicate with external systems and the Internet.

Despite the abstraction, virtual networks still rely on underlying physical network infrastructure, and delays in the physical layer can have a significant impact such as network outages, data loss, or isolation of virtual machines from critical resources. For example, if a physical gateway device starts to experience high processing load, it can impact network performance and the physical gateway device's operational efficiency. One of the consequences may be increased latency and packet loss. As a physical gateway device becomes overwhelmed, its ability to route and process data diminishes leading to delayed packet transmission and packet loss. Real time applications, such as video conferencing, Voice over Internet Protocol (VoIP), or online gaming are especially vulnerable, as they require continuous and smooth data flow. When the packets are delayed or lost, these applications can experience stuttering, dropped calls, or frozen video feeds, frustrating users and disrupting operations. Another issue that arises from high processing loads of physical gateway devices is the decreased throughput via the physical gateway devices and increased likelihood of device failure. The more tasks a physical gateway device has to process, a lesser bandwidth of resources such as Central Processing Unit (CPU) and memory is allocated for each task, leading to reduced physical gateway device throughput. As the strain on the physical gateway device increases, it can cause the physical gateway device to overheat or suffer hardware degradation, leading to crashes or permanent damage.

To overcome such a situation, the subject technology allows the virtual switches to transmit test packets or probe signals to the physical gateway devices. These probes help assess whether the physical gateway devices are experiencing heavy processing load. If the virtual switch detects that a physical gateway device is experiencing a high processing load, the virtual switch can re-route network traffic to other physical gateway devices causing to distribute the processing load evenly across all physical gateway devices. The dynamic and local detection ensures minimal disruption in data transmission and enhances the resilience of the virtual network.

Compared to traditional Transmission Control Protocol (TCP) load balancing mechanisms, the subject technology offers a more localized and efficient method for determining processing loads of physical gateway devices. Compared to TCP load balancing, which operates at the session level and typically assigns connections based on fixed metrics like round-robin, the subject technology offers real-time, dynamic load balancing at the packet level. This enables continuous monitoring of the processing load of each physical gateway device, allowing the system to redirect traffic if any gateway becomes overloaded. Unlike TCP load balancing, which often leads to session “stickiness” and delayed responsiveness to changes in processing loads, this method provides more granular control, distributing traffic evenly and adapting instantly to fluctuating network conditions. The subject technology allows for better resource utilization, lower latency, and enhanced resilience, as it quickly responds to load spikes or failures without manual intervention.

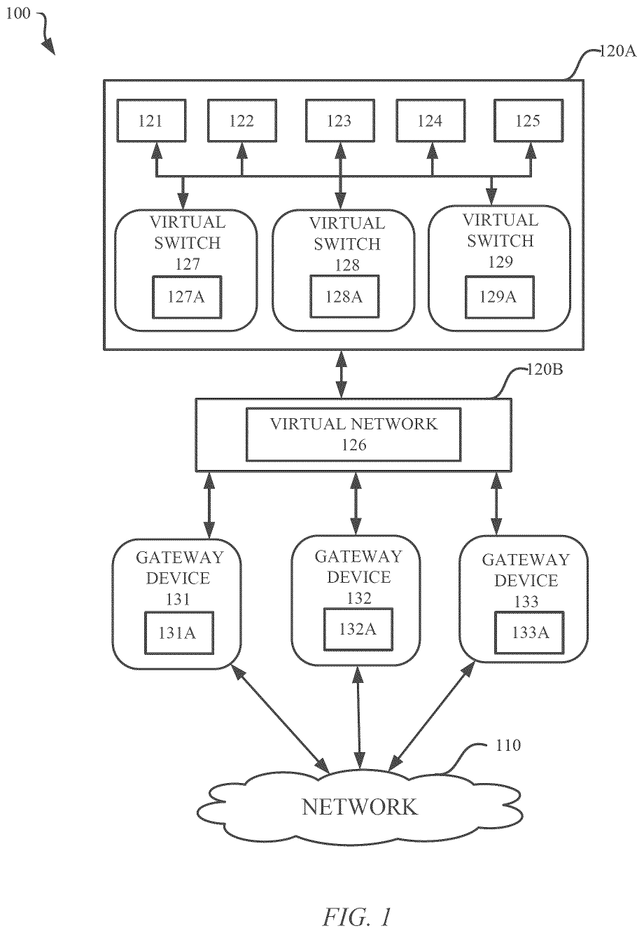

FIG. 1 illustrates an example network environment 100 according to aspects of the subject technology. Not all the depicted components may be used in all implementations, however, and some implementations may include additional or different components than those shown in the figure. Variations in the arrangement and type of the components may be made without departing from the scope of the claims as set forth herein. Additional components, different components, or fewer components may be provided.

The network environment 100 includes a server 120A that can be a part of a data center executing multiple virtual machines (VMs) 121-125 and virtual switches 127-129. For example, the server 120A can execute a hypervisor that allows creation, execution, and management of VMs 121-125 and virtual switches 127-129 by simulating the hardware resources of the server 120A. The network environment 100 also includes a server 120B that executes a virtual network 126. For example, the server 120B can execute another hypervisor to create and execute a virtual network 126 to allow VMs 121-125 to communicate within themselves and with the network 110. The server 120B further includes physical gateway devices 131-133 that are connected to the network 110 to transmit network data from the virtual switches 127-129 to the network 110. The network 110 is not limited to any particular type of network, network topology, or network media. The network 110 may be a local area network (LAN), a wide area network (WAN). The network 110 may be an interconnected network of devices that may include or may be communicatively coupled to the Internet. For explanatory purposes, the network environment 100 is illustrated in FIG. 1 as connected to the server 120A and server 120B. However, the network environment 100 may include any number of servers and/or other computing/networking devices. Furthermore, for explanatory purposes the servers 120A-B are described herein as single servers; however, each of the servers 120A-B may be representative of any number of servers and/or may be part of the same server.

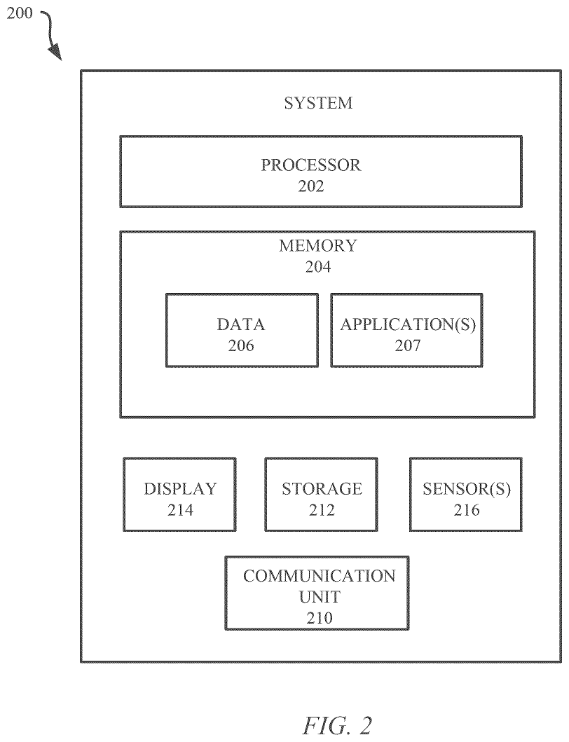

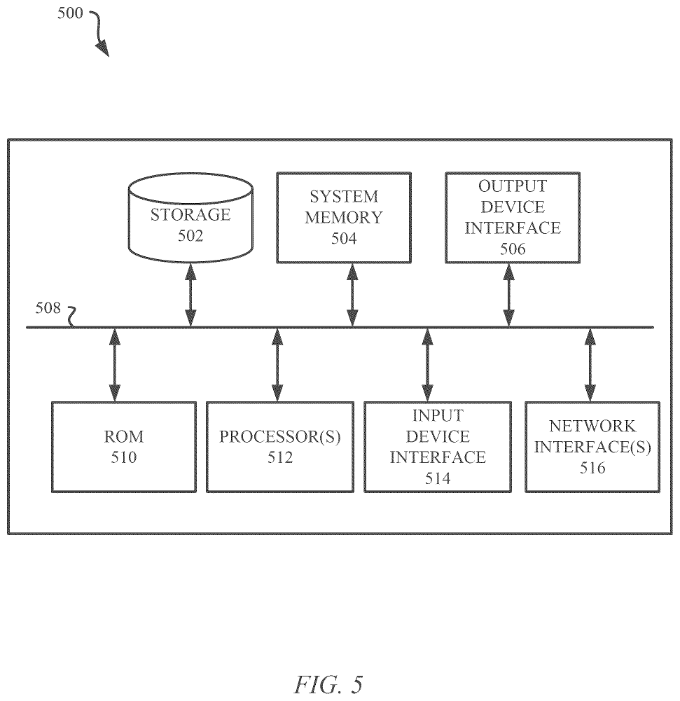

To communicate with the network 110, VMs 121-125 of the server 120A can transmit network data to the virtual switches 127-129 which in turn can transmit the network data to the physical gateway devices 131-133 such as, for example, NICs and/or a physical switching and/or routing device via the virtual network 126 of the server 120B. The physical gateway devices 131-133 perform tasks such as IP routing, NAT, and ensure efficient data flow from the virtual network 126 to the network 110. The virtual switches 127-129 and the physical gateway devices 131-133 further include respective reachability agents 127A-129A and 131A-133A for dynamic detection of network congestion and re-routing of network data in situations where any of the physical gateway devices 131-133 is experiencing high processing loads. The techniques and methods of dynamic detection and re-routing of network data is described below. The server 120A and 120B may be, and/or may include all or part of, the systems discussed below with respect to FIG. 2 and/or with respect to FIG. 5.

FIG. 2 illustrates an example system 200 in accordance with some implementations of the subject technology. In an example, the system 200 may be implemented in the server 120A or the server 120B. In another example, the system 200 may be implemented either in a single device or in a distributed manner in a plurality of devices, the implementation of which would be apparent to a person skilled in the art.

In an example, the system 200 may include a processor 202, memory 204 (memory device) and a communication unit 210. The memory 204 may store data 206 and one or more applications 207. In an example, the system 200 may include or may be communicatively coupled with a storage 212. Thus, the storage 212 may be either an internal storage or an external storage. In the example of FIG. 2, the system 200 includes a display 214, and one or more sensors(s) 216. Sensor(s) 216 may include location sensors (e.g., satellite positioning system sensors), motion sensors (e.g., inertial sensors), and/or depth sensors (e.g., LIDAR sensors, radar sensors, time-of-flight sensors, or the like). However, in one or more implementations, the system 200 may not include a display and/or one or more sensors.

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or evaluating machine learning models, such as large language models, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The memory 204 may include one or more applications 207 that can be executed, and/or are currently being executed, on the system 200, such as a hypervisor or generally any application. The one or more applications 207 can interact with each other or with an operating system of the system 200 using application programming interfaces (API) to send or receive data. The one or more applications 207 can also include respective user interfaces (UI) to facilitate user-interaction, enabling the user to provide inputs and receive output seamlessly. For example, when implemented as the server 120A, the system 200 can execute an application such as a hypervisor to create and/or manage one or more VMs such as the VMs 121-125 and the virtual switches 127-129. As for another example, when implemented in the server 120B, the system 200 can execute another hypervisor to create and/or manage the virtual network 126. One or more of the VMs 121-125, the virtual network 126 and/or the virtual switches 127-129 may be contemporaneously executed on the server 120A and/or the server 120B respectively and managed by their respective hypervisors.

The data 206 may represent, amongst other things, a repository of data processed, received, and generated by one or more processors such as the processor 202. Data may include hardware resource data related to the physical resource of the servers 120A (or the server 120B), such as the processor 202, the CPUs, the GPUs, the memory 204, the storage 212 and network bandwidth. The data 206 may also include VM state data that is related to the status of VMs 121-125, including VM configuration, memory allocation and CPU usage of each of the VMs 121-125. The data 206 can also include network data passing between the VMs 121-125 and the network 110 through virtual switches 127-129.

To determine the processing load of the physical gateway devices, the virtual switches 127-129 and the physical gateway devices 131-133 may include a respective reachability agent (e.g., a software application, a code, or a set of instructions) which allows the virtual switches 127-129 to determine whether the physical gateway devices 131-133 are transmitting data (e.g., data packets) from the VMs 121-125 to the network 110 without delays. For brevity, the techniques, and methods of distribution of network data packets based on the processing load of the physical gateway devices 131-133 is described with reference to the virtual switch 127 and the physical gateway device 131 (also referred to as a first physical gate device 131).

In some embodiments, the reachability agent 127A executing in and/or in conjunction with the virtual switch 127 can generate and transmit a sequence of probe packets to a reachability agent 131A executing in and/or in conjunction with the first physical gateway device 131 via the virtual network 126. In one or more implementations, each probe packet in the sequence can be a UDP packet that includes a header and the payload. The header of the probe packets can include, for example, a source address, a destination address, a length of the entire data packet, and a checksum that can be used for error checking to ensure the integrity of the probe packet. In this case, the source address is the address of the virtual switch 127, the destination address is the address of the first physical gateway device 131, and the payload may include a timestamp indicating the time when the reachability agent 127A provides the probe packet for transmission. In addition to the timestamp, the reachability agent 127A can also include data (e.g., a flag variable, an identifier, etc.) into the payload of the probe packets which can be used by the first physical gateway device 131 to determine that the data packets are probe packets and are different from other data packets received from the virtual switch 127.

After reaching the first physical gateway device 131, the probe packets of the sequence can be added to a processing queue of the first physical gateway device 131 where incoming data packets and tasks wait to be processed by the first physical gateway device 131. The processing queue can follow a first-in, first-out (FIFO) scheduling where data packets and tasks are processed in the order they arrive at the first physical gateway device 131. As the first physical gateway device 131 processes each of the probe packets of the sequence, the reachability agent 131A of the first physical gateway device 131 can respond by generating and transmitting a corresponding respective response packet to the virtual switch 127. In other words, when the reachability agent 131A of the first physical gateway device 131 processes a probe packet, it generates and transmits a corresponding response packet to the virtual switch 127. Thus, if the first physical gateway device 131 processes 10 probe packets, the physical gateway device 131 can respond by generating and transmitting 10 response packets to the virtual switch 127, thereby transmitting a sequence of response packets to the virtual switch 127. However, the sequence of response packets received by the virtual switch 127 may include any number of response packets which may or may not coincide with the number of transmitted probe packets by the first physical gateway device 131.

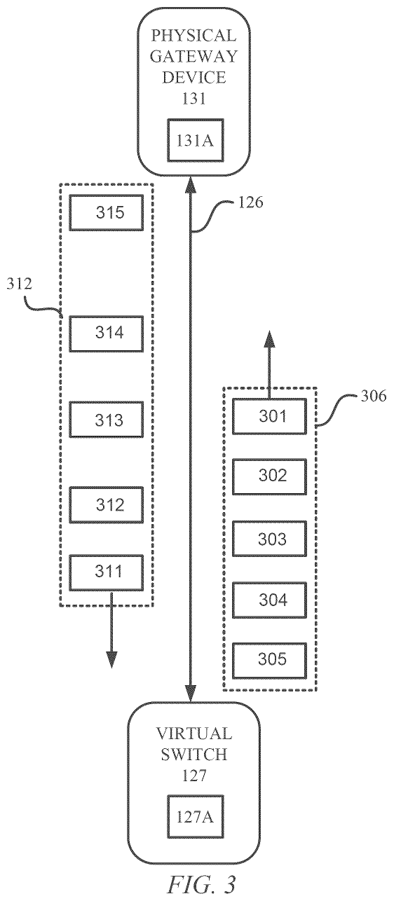

Similar to the probe packets, the response packets can include for example, a header and a payload. In this case, the header of the response packet may include the address of the physical gateway device 131 as the source address, the address of the virtual switch 127 as the destination address. In some embodiments, the reachability agent 131A of the first physical gateway device 131 may include the timestamp from the probe packet into the payload section of the response packet transmitted in response to the probe packet. After receiving the sequence of response packets from the first physical gateway device 131, the reachability agent 127A of the virtual switch 127 can determine whether the first physical gate device 131 is experiencing a high processing load, such as based on detected latency in receiving the response packets and/or detected latency between the receipt of consecutive response packets, which is described further below with reference to FIG. 3.

FIG. 3 illustrates an example use case in which the reachability agent of a virtual switch transmits the sequence of probe packets 306 to the first physical gateway device 131 via the virtual network 126. As seen in FIG. 3, the sequence of probe packets 306 includes five probe packets 301-305; however, the sequence can include any number of probe packets. By sending a sequence of probe packets 306, the reachability agent can monitor not just the connectivity of the first physical gateway device 131, but also its ability to handle a continuous stream of data packets.

In some embodiments, the reachability agent 127A executing in and/or in conjunction with the virtual switch 127, can transmit the probe packets 301-305 to the first physical gateway device 131 at regular time intervals. For example, the reachability agent 127A can transmit a first probe packet 301 at time t, followed by the second probe packet 302 at t+50 milliseconds, the third probe packet 3043 at t+100 milliseconds, the fourth probe packet 304 at t+150 milliseconds and the fifth probe packet 305 at t+200 milliseconds. In response to receiving the sequence of probe packets 306, the reachability agent 131A executing in and/or in conjunction with the first physical gateway device 131 can respond by generating and providing for transmission, a sequence of response packets 312 to the virtual switch 127. In this example, the sequence of response packets 312 include five response packets 311-315, however, the sequence may include any number of response packets which may or may not coincide with the number of transmitted probe packets. In one or more implementations, the interval between transmitted probe packets may be variable. The reachability agent 127A may store the interval between each transmitted packet regardless of whether the interval is static or variable.

In some embodiments, the reachability agent 127A of the virtual switch 127 can determine whether the sequence of response packets 312 was received by the virtual switch 127 and contains a threshold number of response packets. If the sequence of response packets 312 meets or exceeds the threshold number of response packets, the reachability agent 127A can determine that the first physical gateway device 131 is available. Conversely, if the sequence of response packets 312 includes fewer than the threshold number of response packets, the reachability agent 127A can determine that the first physical gateway device 131 is not available. For example, if the threshold number of response packets is set to three and the virtual switch 127 receives four response packets, exceeding the threshold number of response packets, the reachability agent 127A can conclude that the first physical gateway device 131 is available for receiving data packets from the virtual network 126 for transmission to the network 110. On the other hand, if the virtual switch 127 receives only two response packets, the reachability agent 127A can determine that the first physical gateway device 131 is not available.

As described above, when the reachability agent 131A of the first physical gateway device 131 processes a probe packet, it generates and transmits a corresponding response packet to the virtual switch 127. Thus, there is a delay associated with each of the response packets received by the virtual switch 127—the delay caused by time required to transmit the probe packet from the virtual switch 127 to the first physical gateway device 131, the wait time of the probe packet in the processing queue of the first physical gateway device 131, the processing time needed by the first physical gateway device 131 to process the probe packet to generate a response packet and time required to transmit the probe packet from the first physical gateway device 131 to the virtual switch 127. In some embodiments, after receiving the response packets, the reachability agent 127A of the virtual switch 127 can determine the delay associated with the response packets. For example, if the first physical gateway device 131 includes the timestamp from the probe packet into the payload section of the response packet, the reachability agent 127A can extract the timestamp from the response packet and compare the timestamp with the current time, thereby determining the time elapsed since the probe packet was provided for transmission by the virtual switch 127 and when the response packet was received by the virtual switch 127.

In some embodiments, if the delay associated with the response packets of the sequence is less than a first pre-determined threshold amount of time, the reachability agent 127A can determine that the first physical gateway device 131 is experiencing a normal processing load. In other words, the processing load of the first physical gateway device 131 is not high. However, if the delay associated with at least some of the probe packets of the sequence is more than a first pre-determined threshold amount of time, the reachability agent 127A can determine that the first physical gateway device 131 is experiencing a high processing load thereby causing the network data packets and the probe packs to wait longer in the processing queue of the first physical gateway device 131. Continuing with example with reference to FIG. 3, assume the first pre-determined threshold amount of time is 350 millisecond and the response packet 314 that was transmitted by the first physical gateway device 131 after processing the fourth probe packet 304 was received by the virtual switch 127 at t+550 millisecond. In this example, the reachability agent 127A can determine that the fourth probe packet 304 was transmitted at t+150 millisecond and the delay in receiving the response packet was 400 millisecond. Since the delay in receiving the response packet is more than the first pre-determined threshold amount of time, the reachability agent 127A can determine that the first physical gateway device 131 is experiencing a high processing load.

In some embodiments, after receiving the response packets, the reachability agent 127A of the virtual switch 127 can determine whether the delays associated with the response packets are unequal thereby indicating unequal wait times in the processing queue of the first physical gateway device 131. Continuing with example with reference to FIG. 3, assume that the first response packet 311 was received at t+300 millisecond, followed by the second response packet 312 at t+350 millisecond, the third response packet 313 at t+450 millisecond, the fourth response packet 314 at t+550 and the fifth response packet 315 at t+750 millisecond. In this example, the reachability agent 127A can determine that delay associated with the response packets 311-315 is 300 millisecond, 300 millisecond, 350 millisecond, 400 millisecond and 550 millisecond, respectively. In this example, since the delays associated with the response packets are unequal, the reachability agent 127A can determine that the first physical gateway device 131 is experiencing a high processing load.

In some embodiments, the reachability agent 127A of the virtual switch 127 can determine whether the first physical gateway device 131 is experiencing a low, normal, or high processing load based on the wait times in the processing queue of the first physical gateway device 131. For example, if the delay associated with response packets show that the wait time at the processing queue of the first physical gateway device 131 is negligible (or very close to zero), the reachability agent 127A can determine that the first physical gateway device 131 is experiencing a low processing load. As for another example, if the delay associated with response packets show that the wait time at the processing queue of the first physical gateway device 131 is negligible is within an acceptable threshold period of time, the reachability agent 127A can determine that the first physical gateway device 131 is experiencing a normal processing load.

In some embodiments, the reachability agent 127A of the virtual switch 127 can determine whether the difference in delays associated with the response packets are more than a second pre-determined threshold amount of time thereby indicating unequal wait times in the processing queue of the first physical gateway device 131. For example, the reachability agent 127A can determine that the difference in the delay associated with the first 311 and the second 312 response packets is 0 milliseconds, the second 312 and the third 313 response packets is 50 millisecond, the third 313 and the fourth 314 response packet is 50 millisecond, the fourth 314 and the fifth 315 response packets is 150 milliseconds. Assuming that the second pre-determined threshold amount of time is 100 millisecond, the reachability agent 127A can determine that the first physical gateway device 131 is experiencing a high processing load since the difference in the delay associated with the fourth and the fifth response packets is more than the second pre-determined threshold amount of time. As for another example, if the difference in the delay associated with the fourth and the fifth response packets was 75 millisecond, the reachability agent 127A can determine that the first physical gateway device 131 is not experiencing high processing load.

In some embodiments, in response to determining that the first physical gateway device 131 is experiencing a high processing load, the reachability agent 127A can update a weight assigned to the first physical gate device 131 in a forwarding table to indicate that the first physical gate device 131 is experiencing a high processing load. This adjustment in the forwarding table provides for a portion of data packets intended for the first physical gateway device 131 to be re-routed to one or more alternative physical gateway devices (also referred to as second physical gateway devices) that are not experiencing high processing loads. For example, assume that the weights assigned to the physical gate device 131-133 in the forwarding table are 100, 100 and 100 respectively indicating the ratio of the current distribution of network data packets distributed from the virtual switch 127 to the physical gate device 131-133. If the reachability agent 127A determines that the first physical gate device 131 is experiencing a high processing load, the reachability agent 127A can update the weight of the first physical device 131 to 80, thereby reducing the distribution of network data packets from the virtual switch 127 to the first physical gate device 131. In other words, the first physical gateway device 131 would receive 80% of the data packets compared to the second physical gateway device 132. In one or more implementations, in response to determining that the first physical gateway device 131 is experiencing a low processing load, the reachability agent 127A can update the weight of the first physical device 131 to route more data packets to the first physical gateway device 131. For example, the reachability agent 127A can update the weight of the first physical gateway device 131 to 120, thereby increasing the distribution of subsequent data packets to first physical gateway device 131.

In some embodiments, while updating the weight of the first physical device 131, the reachability agent 127A can also update the weight of the second physical gateway devices so as to re-route the portion of the data packets originally intended for the first physical gateway device 131 through the second physical gateway devices. For example, if the reachability agent 127A updates the weight of the first physical device 131 to 80, the reachability agent 127A can also update the weight of the physical device 132-133 to 110.

In some embodiments, the reachability agent 127A of the virtual switch 127 can measure the processing load of the first physical gate device 131 and update the weight associated to the first physical gate device 131 in a forwarding table. For example, the reachability agent 127A after determining that the first physical gate device 131 is experiencing a high processing load, can evaluate the delay associated with the response packets and the difference in delays of subsequent response packets, to determine the severity of the high processing load on the first physical gate device 131. For example, if the delay associated with the response packets is more than the first pre-determined threshold amount of time but less than twice the first pre-determined threshold, the reachability agent 127A can determine that the delay is less severe. However, if the delay associated with the response packets is more than twice the first pre-determined threshold amount of time, the reachability agent 127A can determine that the delay is severe. In some embodiments, the reachability agent 127A can update the weights of the physical gateway devices based on pre-specified heuristics. For example, if the reachability agent 127A determines that the processing load of the first physical device 131 is less severe the reachability agent 127A can update the weight of the first physical device 131 to 60. However, if the reachability agent 127A determines that the processing load of the first physical device 131 is severe, the reachability agent 127A can update the weight of the first physical device 131 to 40. In other embodiments, the reachability agent 127A can update the weights of the physical gateway devices based on pre-specified algorithms or machine learning (ML) models.

In response to determining the processing load of each of the physical gateway devices 131-133, the reachability agent 127A can continuously and/or dynamically update the forwarding table to reflect the processing load of the physical gateway devices 131-133. If a physical gateway device is determined to experience high processing load, the forwarding table is updated to ensure that a portion of the data packets are not sent to the physical gateway device and alternative gateways are prioritized. For example, if the first physical gateway device 131 is experiencing high processing load, the virtual switch 127 can determine from the forwarding table, one or more second physical gateway devices that are not experiencing high processing load. In this example, assuming that the physical gateway devices 132-133 are not experiencing high processing load, the reachability agent 127A can instruct the virtual switch 127 to re-route a portion of the subsequent data packet transmissions from the virtual switch 127 to the first physical gateway device 131 to one or more second physical gateway devices 132-133.

In some embodiments, the reachability agent 127A of the virtual switch 127 can determine the portion of the subsequent data packet transmissions that is to be re-routed to one or more second physical gateway devices that are not experiencing high processing load based on the weights assigned to the physical gateway devices on the forwarding table. For example, if the weight associated to the first physical device 131 is 60, the reachability agent 127A can instruct the virtual switch 127 to reduce the distribution of data packets originally intended for the first physical gateway device 131 by 40%. In other words, the reachability agent 127A can instruct the virtual switch 127 to distribute only 60% of the data packets originally intended for the first physical gateway device 131 to the first physical gateway device 131. Simultaneously, the reachability agent 127A can instruct the virtual switch 127 to re-route the remaining 40% of the data packets originally intended for the first physical gateway device 131 to one or more second physical devices 132-133.

In some embodiments, the reachability agent 127A can monitor the processing load of multiple physical gateway devices in real time. For example, since the virtual switch 127 is connected to physical gateway devices 131-133 via the virtual network 126, the reachability agent 127A can simultaneously transmit additional sequence of probe packets to a respective reachability agents 131A-133A on each respective physical gateway device 131-133. By receiving and evaluating the additional sequence of response packets from the physical gateway devices 131-133, the reachability agent 127A can determine the processing load of each of the physical gateway devices 131-133 in real time. For example, while the virtual switch 127 is re-routing a portion of subsequent data packet transmissions to one or more second physical gateway devices 132-133, the reachability agent 127A can contemporaneously transmit one or more additional sequence of probe packets to the first physical gateway device 131. For example, the virtual switch 127 can transmit an additional sequence of probe packets to the first physical gateway device 131 at regular time intervals.

If the processing load of the first physical gateway device 131 falls below the pre-determined threshold, the reachability agent 131A of the first physical gateway device 131 may respond to the one or more additional sequence of probe packets by generating and transmitting response packets to the virtual switch 127 within the first pre-determined threshold amount of time. In response, the reachability agent 127A of the virtual switch 127 can determine that the processing load of the first physical gateway device 131 is below the pre-determined threshold. In some embodiments, in response to determining that the processing load of the first physical gateway device 131 is below the pre-determined threshold, the reachability agent 127A can update the weight assigned to the first physical gate device 131 on the forwarding table. The update indicates that the processing load of the first physical gateway device 131 is below the pre-determined threshold, allowing subsequent data packets to be routed through the physical gateway device 131 without re-routing a portion to secondary physical gateway devices.

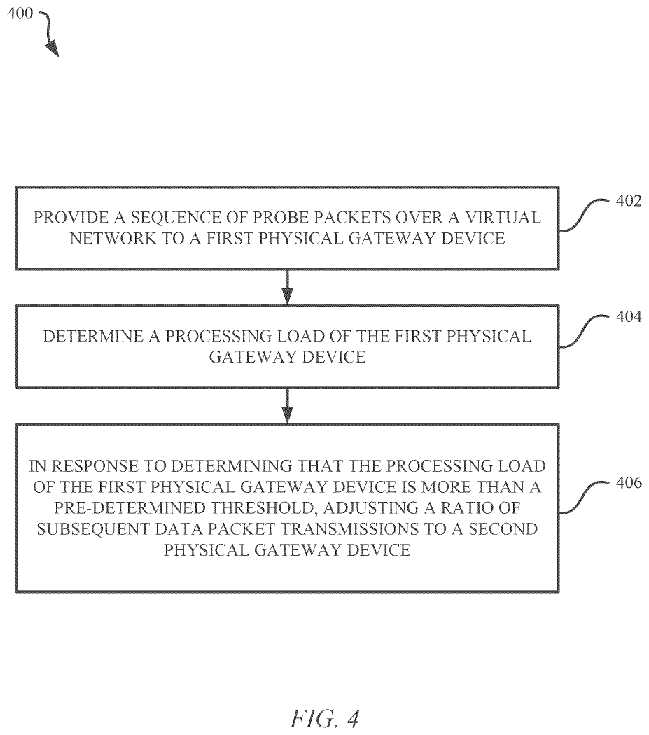

FIG. 4 is a flowchart illustrating an example process 400 for determining a processing load of a first physical gateway device according to aspects of the subject technology. For explanatory purposes, the process 400 is primarily described herein with reference to the server 120 of FIG. 1. However, the process 400 is not limited to the server 120 of FIG. 1, and one or more blocks (or operations) of the process 400 may be performed by one or more other suitable devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

At block 402, the reachability agent 127A executing on, and/or in conjunction with, the virtual switch 127 provides a sequence probe packets for transmission to a first physical gateway device 131. For example, the reachability agent 127A executing in and/or in conjunction with the virtual switch 127 can generate and transmit a sequence of probe packets to a reachability agent 131A executing in and/or in conjunction with the first physical gateway device 131 via the virtual network 126. One or more probe packets in the sequence can be a UDP packet that includes a header and the payload. The header of the probe packets can include, for example, a source address, a destination address, a length of the entire data packet, and a checksum that can be used for error checking to ensure the integrity of the probe packet. In this case, the source address is the address of the virtual switch 127, the destination address is the address of the first physical gateway device 131, and the payload may include a timestamp indicating the time when the reachability agent 127A provides the probe packet for transmission. In addition to the timestamp, the reachability agent 127A can also include data (e.g., a flag variable, an identifier, etc. ,) into the payload of the probe packets which can be used by the first physical gateway device 131 to determine that the data packets are probe packets and are different from other data packets received from the virtual switch 127.

At block 404, the reachability agent 127A of the virtual switch 127 determines a processing load of the first physical gateway device 131. For example, after receiving the response packets, the reachability agent 127A of the virtual switch 127 can determine the delay associated with the response packets. If the delay associated with the response packets of the sequence is less than a first pre-determined threshold amount of time, the reachability agent 127A can determine that the first physical gateway device 131 is experiencing a normal processing load. In other words, the processing load of the first physical gateway device 131 may not be high. However, if the delay associated with at least some of the probe packets of the sequence is more than a first pre-determined threshold amount of time, the reachability agent 127A can determine that the first physical gateway device 131 is experiencing a high processing load thereby causing the network data packets and the probe packs to wait longer in the processing queue of the first physical gateway device 131. The reachability agent 127A of the virtual switch 127 can determine whether the delays associated with the response packets are unequal thereby indicating unequal wait times in the processing queue of the first physical gateway device 131. In some embodiments, the reachability agent 127A of the virtual switch 127 can determine whether the difference in delays associated with the response packets are more a second pre-determined threshold amount of time thereby indicating unequal wait times in the processing queue of the first physical gateway device 131 and a high processing load on the first physical gateway device 131.

At block 406, the reachability agent 127A of the virtual switch 127 adjusts a ratio of subsequent data packet transmissions that are provided over the virtual network to the first physical gateway device. For example, in response to determining that the first physical gateway device 131 is experiencing a high processing load, the reachability agent 127A can update a weight assigned to the first physical gate device 131 in a forwarding table to indicate that the first physical gate device 131 is experiencing a high processing load. This adjustment in the forwarding table provides for a portion of data packets intended for the first physical gateway device 131 to be re-routed to one or more alternative physical gateway devices (also referred to as second physical gateway devices) that are not experiencing high processing loads. While updating the weight of the first physical device 131, the reachability agent 127A can also update the weight of the second physical gateway devices so as to re-route the portion of the data packets that were originally intended for the first physical gateway device 131, to the second physical gateway devices. The reachability agent 127A of the virtual switch 127 can measure the processing load of the first physical gate device 131 and update the weight associated to the first physical gate device 131 in a forwarding table. For example, the reachability agent 127A after determining that the first physical gate device 131 is experiencing a high processing load, can evaluate the delay associated with the response packets of the sequence and the difference in delays, to determine the severity of the high processing load on the first physical gate device 131. Depending on the severity of the high processing load on the first physical gate device 131, the reachability agent 127A can update the weight of the first physical device 131.

FIG. 5 illustrates an electronic system 500 with which one or more implementations of the subject technology may be implemented. The electronic system 500 can be, and/or can be a part of, server 120 shown in FIG. 1. The electronic system 500 may include various types of computer readable media and interfaces for various other types of computer readable media. The electronic system 500 includes a bus 508, one or more processing unit(s) 512, a system memory 504 (and/or buffer), a ROM 510, a permanent storage device 502, an input device interface 514, an output device interface 506, and one or more network interfaces 516, or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random-access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to one or more networks and/or to one or more network nodes through the one or more network interface(s) 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

Implementations within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of training data collection, the present technology can be configured to allow users to select to “opt in” or “opt out” of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, training data can be selected based on aggregated non-personal information data or a bare minimum amount of personal information, such as the content being handled only on the user's device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method, comprising:
providing, for transmission, by a virtual switch, a sequence of probe packets over a virtual network to a first physical gateway device;
determining, by the virtual switch, a processing load of the first physical gateway device based at least in part on whether a sequence of response packets was received from the first physical gateway device after providing the sequence of probe packets for transmission to the first physical gateway device and a delay associated with at least one response packet of the sequence of response packets received from the first physical gateway device after providing the sequence of probe packets for transmission to the first physical gateway device; and
in response to determining, by the virtual switch, that the processing load of the first physical gateway device is more than a pre-determined threshold, adjusting a ratio of subsequent data packet transmissions that are provided over the virtual network to the first physical gateway device.

2. The computer-implemented method of claim 1, wherein providing for transmission the sequence of probe packets comprises providing each respective probe packet from the sequence of probe packets for transmission at a regular time interval.

3. The computer-implemented method of claim 1, wherein determining the processing load of the first physical gateway device comprises determining that the respective delays associated with at least some of the respective response packets of the sequence of response packets is more than a first pre-determined threshold amount of time of providing the corresponding respective probe packets of the sequence of probe packets for transmission to the first physical gateway device.

4. The computer-implemented method of claim 1, wherein determining the processing load of the first physical gateway device comprises determining that the respective delays associated with at least some of the respective response packets of the sequence of response packets are not equal.

5. The computer-implemented method of claim 4, wherein determining the processing load of the first physical gateway device further comprises determining that a difference in the delays associated with at least some of the probe packets of the sequence of response packets is within a second pre-determined threshold amount of time.

6. The computer-implemented method of claim 1, wherein adjusting the ratio of subsequent data packet transmissions over the virtual network to the first physical gateway device comprises:
determining a measure of the processing load experienced by the first physical gateway device;
updating a weight associated with the first physical gateway device in a forwarding table based on the measure of the processing load;
adjusting the ratio of the subsequent data packet transmissions over the virtual network to the first physical gateway device based at least in part on the updated forwarding table.

7. The computer-implemented method of claim 6, further comprises re-routing a portion of the subsequent data packet transmissions from the virtual switch to a second physical gateway device over the virtual network based at least in part on the updated forwarding table.

8. The computer-implemented method of claim 7, wherein in response to re-routing a portion of the subsequent data packet transmissions from the virtual switch to a second physical gateway device, providing for transmission, by the virtual switch, one or more additional sequence of probe packets over the virtual network to the first physical gateway device to continue to monitor the processing load of the first physical gateway device.

9. The computer-implemented method of claim 8, further comprising:
in response to determining that the processing load of the first physical gateway device is below the pre-determined threshold based at least in part on whether one or more additional sequence of response packets was received after providing the one or more additional sequence of probe packets for transmission to the physical gateway device and a delay associated with each response packet of the one or more additional sequence of response packets received from the first physical gateway device after providing the sequence of probe packets for transmission to the first physical gateway device:
updating the weight associated to the first physical gateway device in the forwarding table based on a measure of the monitored processing load; and
re-routing the subsequent data packet transmissions from the virtual switch to the first physical gateway device over the virtual network based at least in part on the updated forwarding table.

10. A non-transitory machine-readable medium comprising instructions that, when executed by one or more processors, cause the one or more processors to perform operations comprising:
providing, for transmission, by a virtual switch, a sequence of probe packets over a virtual network to a first physical gateway device;
determining, by the virtual switch, a processing load of the first physical gateway device based at least in part on whether a sequence of response packets was received from the first physical gateway device after providing the sequence of probe packets for transmission to the first physical gateway device and a delay associated with at least one response packet of the sequence of response packets received from the first physical gateway device after providing the sequence of probe packets for transmission to the first physical gateway device; and
in response to determining, by the virtual switch, that the processing load of the first physical gateway device is more than a pre-determined threshold, adjusting a ratio of subsequent data packet transmissions that are provided over the virtual network to the first physical gateway device.

11. The non-transitory machine-readable medium of claim 10, wherein providing for transmission the sequence of probe packets comprises providing a probe packet from the sequence of probe packets for transmission at regular time intervals.

12. The non-transitory machine-readable medium of claim 10, wherein determining the processing load of the first physical gateway device comprises determining that the delays associated with at least some of the probe packets of the sequence of response packets is more than a first pre-determined threshold amount of time of providing the sequence of probe packets for transmission to the first physical gateway device.

13. The non-transitory machine-readable medium of claim 10, wherein determining the processing load of the first physical gateway device comprises determining that the delays associated with at least some of the response packets of the sequence of response packets are not equal.

14. The non-transitory machine-readable medium of claim 13, wherein determining the processing load of the first physical gateway device further comprises determining that a difference in the delays associated with at least some of the probe packets of the sequence of response packets is within a second pre-determined threshold amount of time.

15. The non-transitory machine-readable medium of claim 10, wherein adjusting the ratio of subsequent data packet transmissions over the virtual network to the first physical gateway device comprises:
determining a measure of the processing load experienced by the first physical gateway device;
updating a weight associated with the first physical gateway device in a forwarding table based on the measure of the processing load;
adjusting the ratio of the subsequent data packet transmissions over the virtual network to the first physical gateway device based at least in part on the updated forwarding table.

16. The non-transitory machine-readable medium of claim 15, further comprises re-routing a portion of the subsequent data packet transmissions from the virtual switch to a second physical gateway device over the virtual network based at least in part on the updated forwarding table.

17. A device comprising:
a memory; and
at least one processor configured to:
provide, for transmission, by a virtual switch, a sequence of probe packets over a virtual network to a first physical gateway device;
determine, by the virtual switch, a processing load of the first physical gateway device based at least in part on whether a sequence of response packets was received from the first physical gateway device after providing the sequence of probe packets for transmission to the first physical gateway device and a delay associated with at least one response packet of the sequence of response packets received from the first physical gateway device after providing the sequence of probe packets for transmission to the first physical gateway device; and
in response to determining, by the virtual switch, that the processing load of the first physical gateway device is more than a pre-determined threshold, adjust a ratio of subsequent data packet transmissions that are provided over the virtual network to the first physical gateway device.

18. The device of claim 17, wherein providing for transmission the sequence of probe packets comprises providing a probe packet from the sequence of probe packets for transmission at regular time intervals.

19. The device of claim 17, wherein determining the processing load of the first physical gateway device comprises determining that the delays associated with at least some of the probe packets of the sequence of response packets is more than a first pre-determined threshold amount of time of providing the sequence of probe packets for transmission to the first physical gateway device.

20. The device of claim 17, wherein determining the processing load of the first physical gateway device comprises determining that the delays associated with at least some of the response packets of the sequence of response packets are not equal.
